(19) United States
(12) Patent Application Publication
(10) Pub. No.: US 2009/0268191 A1
(43) Pub. Date: Oct. 29, 2009

(54) PLANAR MOTOR, POSITIONING APPARATUS, EXPOSURE APPARATUS, AND DEVICE MANUFACTURING METHOD

(75) Inventor: Mitsuya Sato, Yokohama-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/518,376

(22) PCT Filed: Mar. 6, 2008
(86) PCT No.: PCT/JP2008/054565

§ 371 Date: Jun. 9, 2009

(30) Foreign Application Priority Data
Mar. 9, 2007 (JP) 2007-060906

(51) Int. Cl. G03B 27/58; H02K 41/03

(52) U.S. Cl. 355/72; 310/12.06; 310/12.17

(57) ABSTRACT

A planar motor includes a stator in which a plurality of convex portions each containing a magnetic material are arranged, and a movable element which faces the stator. The movable element has a plurality of coils, and moves in at least the x direction by controlling electric currents flowing through the plurality of coils. Each convex portion of the stator has different dimensions in the y direction at least at two positions on a straight line along the x direction.

### TECHNICAL FIELD

The present invention relates to a planar motor having a stator in which a plurality of convex portions each containing a magnetic material are arranged and a movable element which faces the stator, a positioning apparatus having the planar motor, an exposure apparatus having the planar motor, and a device manufacturing method using the exposure apparatus.

### BACKGROUND ART

FIG. 7 is a view showing the operation principle of a linear motor. The linear motor comprises a stator 100 and movable element 200. The stator 100 is also often called a platen. The stator 100 is formed by periodically arranging a plurality of convex portions (projecting portions) 2 each containing a magnetic material. The portion between the convex portions 2 is called a recessed portion 3. The movable element 200 faces the stator 100. The movable element 200 comprises a core 202 and a plurality of coils 5 and 6 wound around the core 202. The movable element 200 moves by controlling electric currents flowing through the plurality of coils 5 and 6 of the movable element 200. The movable element 200 can be provided with permanent magnets 7 and 8. Providing the permanent magnets 7 and 8 to the movable element 200 allows it to be at rest stably even when current supply to all the coils 5 and 6 is shut off. The core 202 has a plurality of teeth 4 which face the arrangement of the convex portions 2 of the stator 100. The plurality of teeth 4 are grouped into tooth groups 11, 12, 13, and 14 each having a predetermined number of teeth. The convex portions 2 of the stator 100 are arranged at an arrangement pitch τ. 7A, 7B, 7C, and 7D in FIG. 7 show states in which the movable element 200 is located at the origin, the τ/4 position, the 2τ/4 position, and the 3τ/4 position, respectively, assuming the position of a given convex portion 2 of the stator 100 as an origin.

In 7A of FIG. 7, an electric current is supplied to the first coil 5 in a direction indicated by an arrow in 7A of FIG. 7 so that a magnetic flux which runs through the tooth group 11 and that which runs out from the permanent magnet 7 merge into a maximum magnetic flux. This produces a force to move the movable element 200 to the left side. With this operation, the movable element 200 moves, as shown in 7A, 7B, 7C, and 7D of FIG. 7.

FIG. 8 is a view showing an arrangement example of a movable element of a planar motor. A movable element 300 can be formed as one structure which comprises, for example, two movable elements 200X for moving it in the x direction and two movable elements 200Y for moving it in the y direction. The movable elements 200X and 200Y are equivalent to the movable element 200 shown in FIG. 7. With this arrangement, the movable element 300 can be driven in the x and y directions. The movable element 300 has an air ejection nozzle 16 to levitate it from the stator 100.

FIGS. 9A and 9B show a method of manufacturing a stator of a planar motor and the arrangement of the stator. Silicon steel sheets 20 as magnetic materials are stacked in the y direction to form a plate which extends in the x and y directions. As shown in FIG. 9A, the plate surface is then cut to form recessed portions (grooves) 3 which extend in the x and y directions, thereby forming periodical, square convex portions 2 on the plate surface. As shown in FIG. 9B, the recessed portions 3 are then filled with an epoxy resin 21. After the epoxy resin 21 hardens, the structure surface is planarized. A stator 100 can thus be manufactured.

Note that silicon steel sheets 20 are stacked to reduce any eddy-current loss caused as the movable element 300 moves. In the arrangement example shown in FIG. 9A, any eddy-current loss can be reduced only when the movable element moves to the silicon steel sheets (in the x direction). Therefore, the silicon steel sheets are normally oriented in a direction in which the planar motor requires a larger thrust.

FIG. 10 is a perspective view showing the schematic arrangement of a planar motor. A movable element 300 moves in the x and y directions in accordance with the above-described driving principle while levitating above a stator 100 by air by about, for example, 20 μm.

A conventional planar motor has a stator in which each convex portion has a rectangular shape defined by sides parallel in the moving direction of a movable element and in a direction perpendicular to it. Letting τ be the arrangement pitch of the convex portions in the moving direction of the movable element, and D be the dimension of each convex portion in the moving direction, D/τ=0.5 (see FIGS. 4 and 5 in Japanese Patent Laid-Open No. 2005-261063). It is thought to be difficult to obtain a high thrust in such an arrangement of the convex portions.

### DISCLOSURE OF INVENTION

The present invention has been made in consideration of the above-described problem recognized by the inventor of the present invention, and has as its object to improve, for example, the thrust of a planar motor.

According to the first aspect of the present invention, there is provided a planar motor comprising a stator in which a plurality of convex portions each containing a magnetic material are arranged, and a movable element which faces the stator, the movable element including a plurality of coils and moving in at least a first direction by controlling electric currents flowing through the plurality of coils, wherein each convex portion has different dimensions in a second direction perpendicular to the first direction at least at two positions on a straight line along the first direction.

According to the second aspect of the present invention, there is provided a positioning apparatus which positions an object, comprising a planar motor defined in the first aspect as a driving unit of the positioning apparatus.

According to the third aspect of the present invention, there is provided an exposure apparatus which transfers a pattern of an original onto a substrate, comprising a positioning apparatus configured to position the substrate, a projection optical system configured to project the pattern of the original onto the substrate, and a planar motor defined in the first aspect as a driving unit of the positioning apparatus.

According to the fourth aspect of the present invention, there is provided a device manufacturing method comprising the steps of exposing a substrate to light using an exposure apparatus defined in the third aspect, and developing the substrate.

According to the fifth aspect of the present invention, there is provided a planar motor comprising a stator in which a plurality of convex portions each containing a magnetic material are arranged, and a movable element which faces the stator, the movable element including a plurality of coils and a plurality of teeth, wherein the movable element moves in at least a first direction using a magnetic flux generated by controlling electric currents flowing through the plurality of coils, and as the teeth and the convex portions move relative to each other upon the movement of the movable element in the first direction, a spatial derivative of a magnetic flux running area, as an area of a region in which the magnetic flux runs through a portion in which the plurality of convex portions overlap the teeth, gradually increases and decreases.

According to the sixth aspect of the present invention, there is provided a planar motor comprising a stator including a recessed portion and a plurality of convex portions each containing a magnetic material, and a movable element which faces the stator, the movable element including a plurality of coils, wherein the movable element moves by controlling electric currents flowing through the plurality of coils, each of the convex portions is a quadrangle in which four corners are adjacent to each other and four sides are adjacent to the recessed portion, and the movable element moves in a direction along at least one of axes running on diagonals of each of the convex portions.

According to the seventh aspect of the present invention, there is provided a planar motor comprising a stator in which a plurality of convex portions each containing a magnetic material are arranged, and a movable element which faces the stator, the movable element including a plurality of coils, wherein the movable element moves by controlling electric currents flowing through the plurality of coils, and each of the convex portions has a shape including four corners, and the convex portions are arranged such that an interval between an edge of a given convex portion and an edge of a convex portion closest to the given convex portion becomes less than half an interval between the center of the given convex portion and the center of the convex portion closest to the given convex portion.

According to the eighth aspect of the present invention, there is provided a planar motor comprising a stator in which a plurality of convex portions each containing a magnetic material are arranged, and a movable element which faces the stator, the movable element including a plurality of coils, wherein the movable element moves in at least a first direction by controlling electric currents flowing through the plurality of coils, and each of the convex portions has a shape including eight corners, and the convex portions are arranged such that an interval between an edge of a given convex portion and an edge of a convex portion closest to the given convex portion becomes less than half an interval between the center of the given convex portion and the center of the convex portion closest to the given convex portion.

Further features of the present invention will become apparent from the following description of exemplary embodiments with reference to the attached drawings.

### BRIEF DESCRIPTION OF DRAWINGS

FIG. 1A is a view showing an arrangement example of a stator according to a preferred embodiment of the present invention;

FIG. 1B is a view showing the arrangement of a stator according to a comparative example;

FIG. 2A is a view for explaining a magnetic flux which runs through convex portions of the stator shown in FIG. 1A;

FIG. 2B is a view for explaining a magnetic flux which runs though convex portions of the stator shown in FIG. 1B;

FIG. 3 is an explanatory view associated with tooth Duty;

FIG. 4A is a view showing convex portions of a stator according to the first modification;

FIG. 4B is a view showing convex portions of a stator according to the second modification;

FIG. 4C is a view showing convex portions of a stator according to the third modification;

FIG. 4D is a view showing convex portions of a stator according to the fourth modification;

FIG. 5 is a view for explaining a method of forming the convex portions shown in FIG. 4B;

FIG. 6 is a view for explaining a method of forming the stator shown in FIG. 1A;

FIG. 7 is a view showing the operation principle of a linear motor;

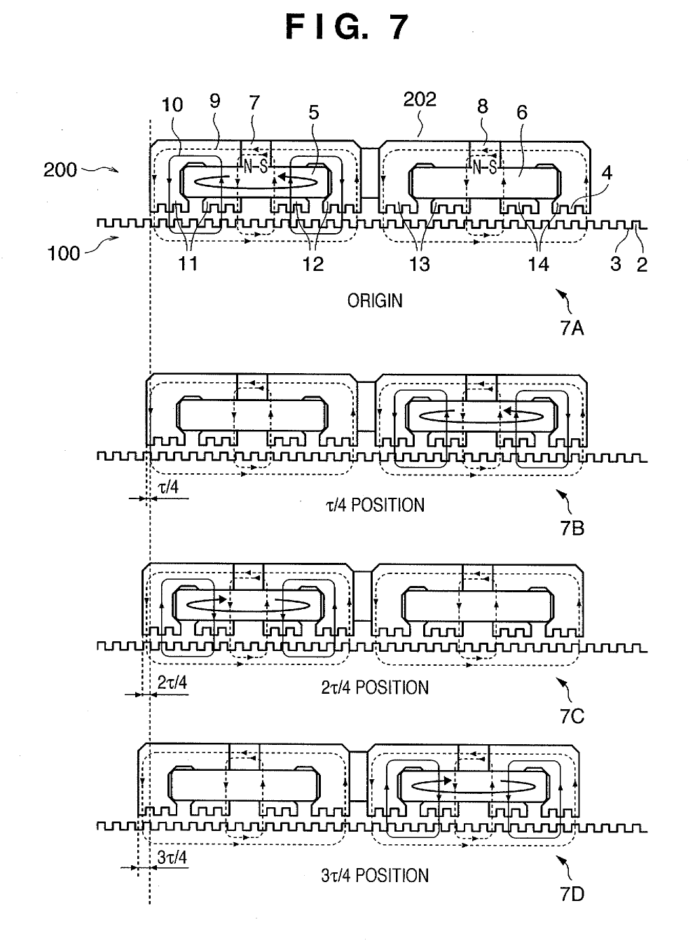

FIG. 8 is a view showing an arrangement example of a movable element of a planar motor;

FIGS. 9A and 9B are views showing a method of manufacturing a stator of a planar motor and the arrangement of the stator;

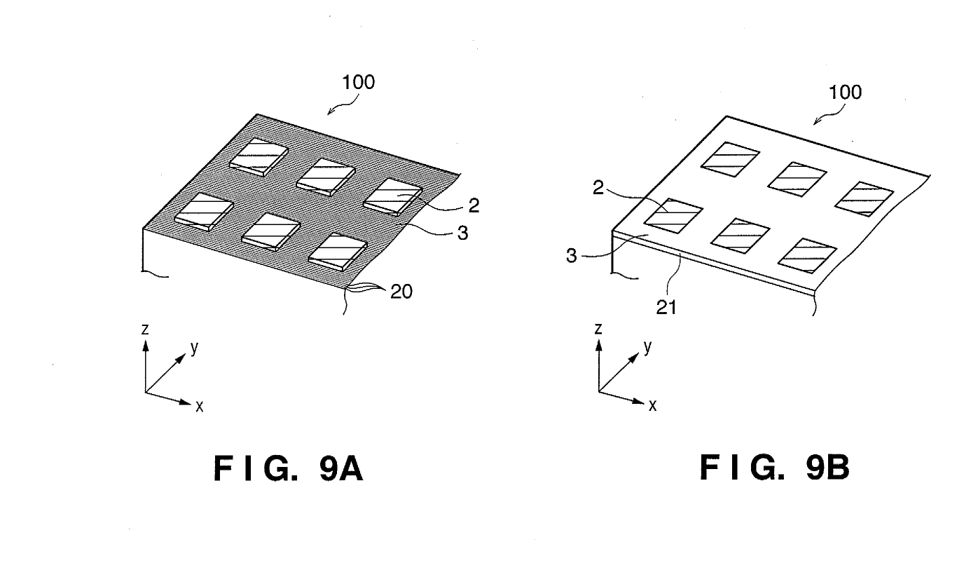

FIG. 10 is a perspective view showing the schematic arrangement of a planar motor;

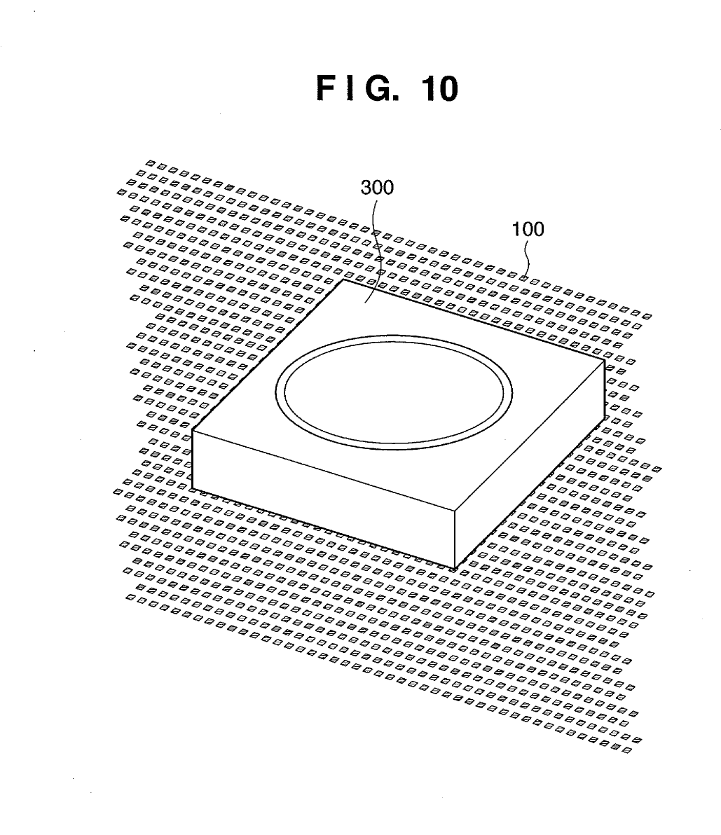

FIG. 11 is a perspective view showing the schematic arrangement of a planar motor according to the preferred embodiment of the present invention;

FIG. 12 is a view schematically showing the arrangements of a positioning apparatus and exposure apparatus according to the preferred embodiment of the present invention;

FIG. 13 is a flowchart illustrating the overall sequence of a process of manufacturing a semiconductor device; and

FIG. 14 is a flowchart illustrating the detailed sequence of the wafer process.

### BEST MODE FOR CARRYING OUT THE INVENTION

A preferred embodiment of the present invention will be described below with reference to the accompanying drawings.

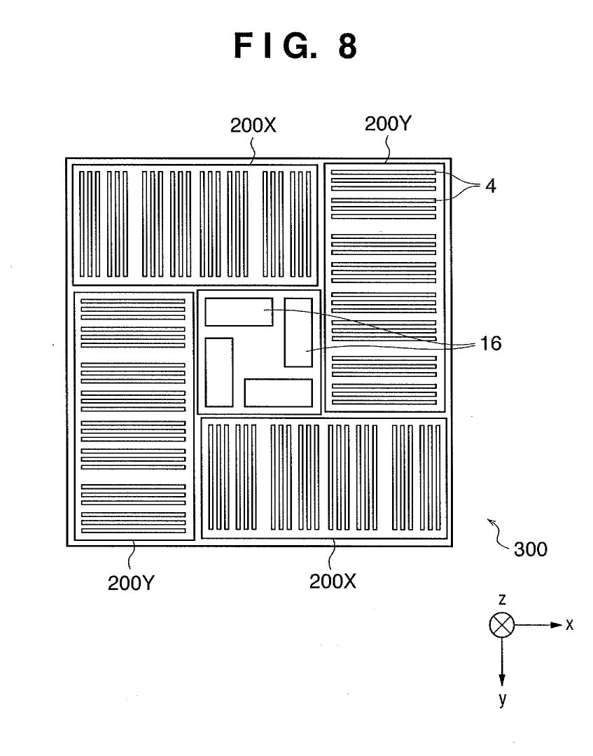

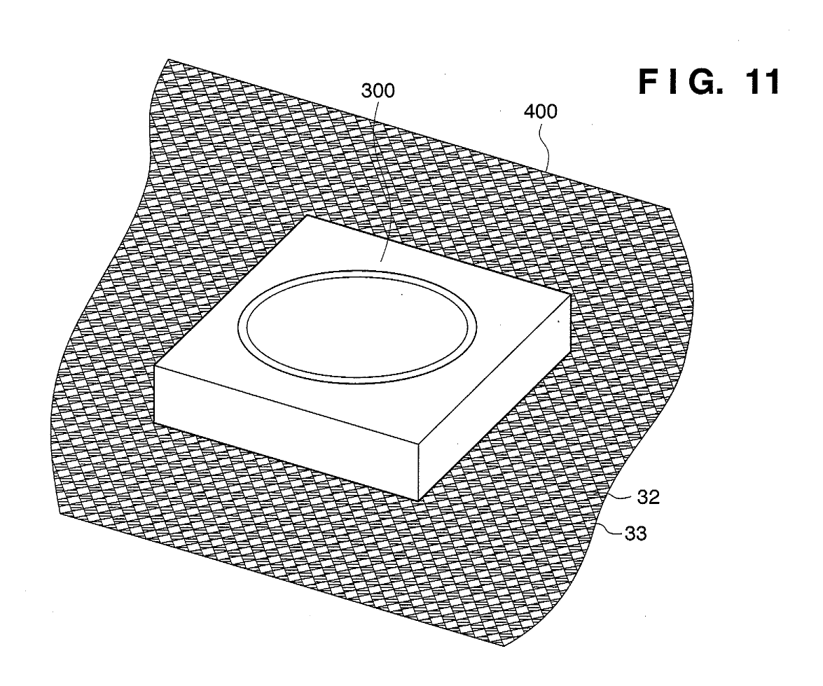

FIG. 11 is a perspective view showing the schematic arrangement of a planar motor. The planar motor according to the preferred embodiment of the present invention comprises a stator 400 and a movable element 300 which faces the stator 400. The movable element 300 has a plurality of coils. The movable element 300 can move in at least one direction by controlling electric currents flowing through the plurality of coils. The movable element 300 typically moves in the x direction and/or y direction by controlling electric currents flowing through the plurality of coils. As shown in FIG. 8, the movable element 300 can be formed as one structure which comprises, for example, two movable elements 200X for moving it in the x direction and two movable elements 200Y for moving it in the y direction. The movable element 300 has an air ejection nozzle 16 to levitate it from a stator 100.

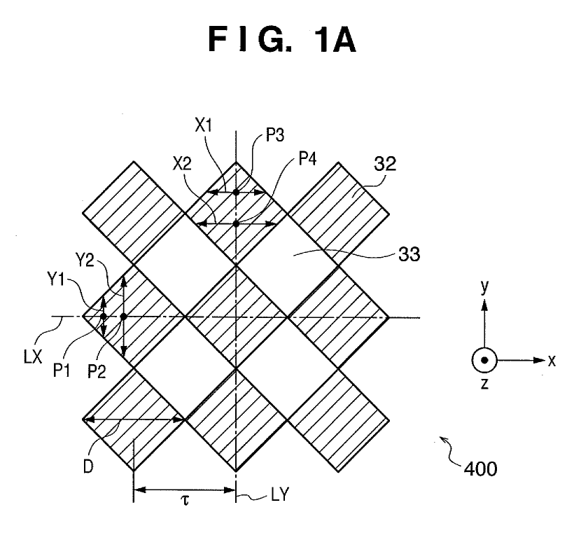

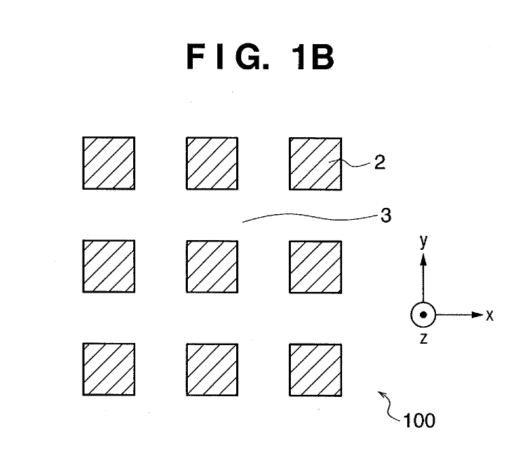

FIG. 1A is a view showing an arrangement example of the stator 400. The stator 400 is formed by arranging a plurality of convex portions 32 each containing a magnetic material. The portion between the convex portions 32 of the stator 400 is a recessed portion 33. Each convex portion 32 has different dimensions Y1 and Y2 in the y direction (second direction) perpendicular to the x direction (first direction) at least at two positions P1 and P2 on a straight line LX along the x direction (first direction). Each convex portion 32 also has different dimensions X1 and X2 in the x direction (first direction) perpendicular to the y direction (second direction) at least at two positions P3 and P4 on a straight line LY along the y direction (second direction).

In the example shown in FIG. 1A, the plurality of convex portions 32 are arranged in a checkerboard pattern. Also in the example shown in FIG. 1A, each convex portion 32 has a contour including sides parallel to neither the x direction (first direction) nor the y direction (second direction).

Also in the example shown in FIG. 1A, letting τ be the arrangement pitch of the plurality of convex portions 32 in the x direction (first direction), and D be the maximum dimension of each core 32 in the x direction (first direction), D/τ=1, which satisfies D/τ>0.5. Each core 32 may satisfy, for example, D/τ>0.9, D/τ>0.8, D/τ>0.7, or D/τ>0.6.

FIG. 1B is a view showing the arrangement of a stator according to a comparative example. In the comparative example shown in FIG. 1B, each convex portion 2 has equal dimensions in the y direction (second direction) perpendicular to the x direction (first direction) at least at two positions on a straight line along the x direction (first direction). Each convex portion 32 also has equal dimensions in the x direction (first direction) perpendicular to the y direction (second direction) at least at two positions on a straight line along the y direction (second direction).

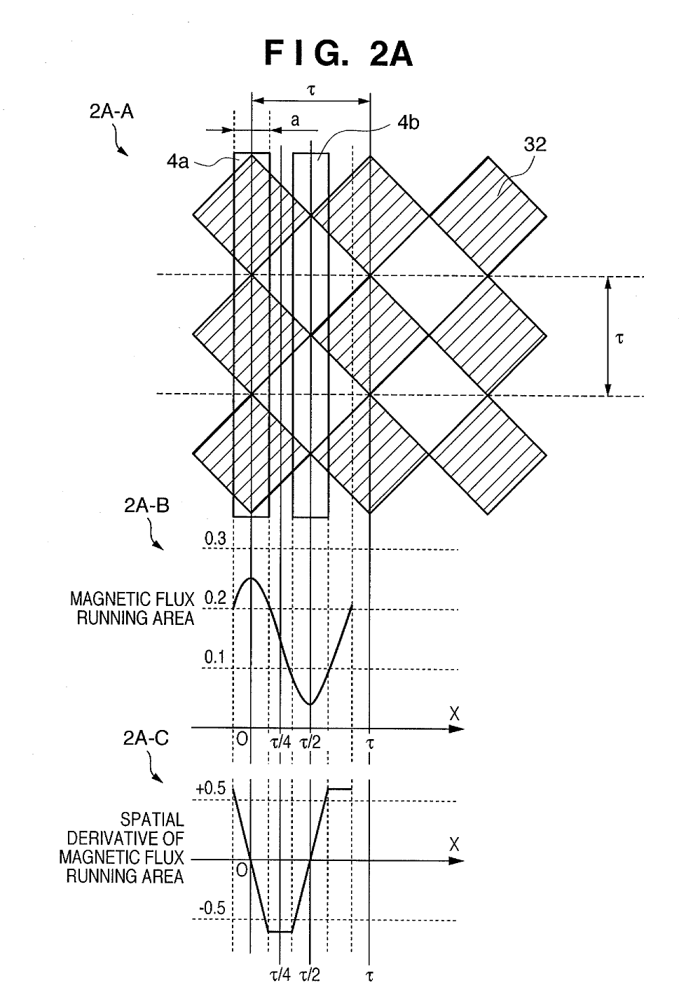

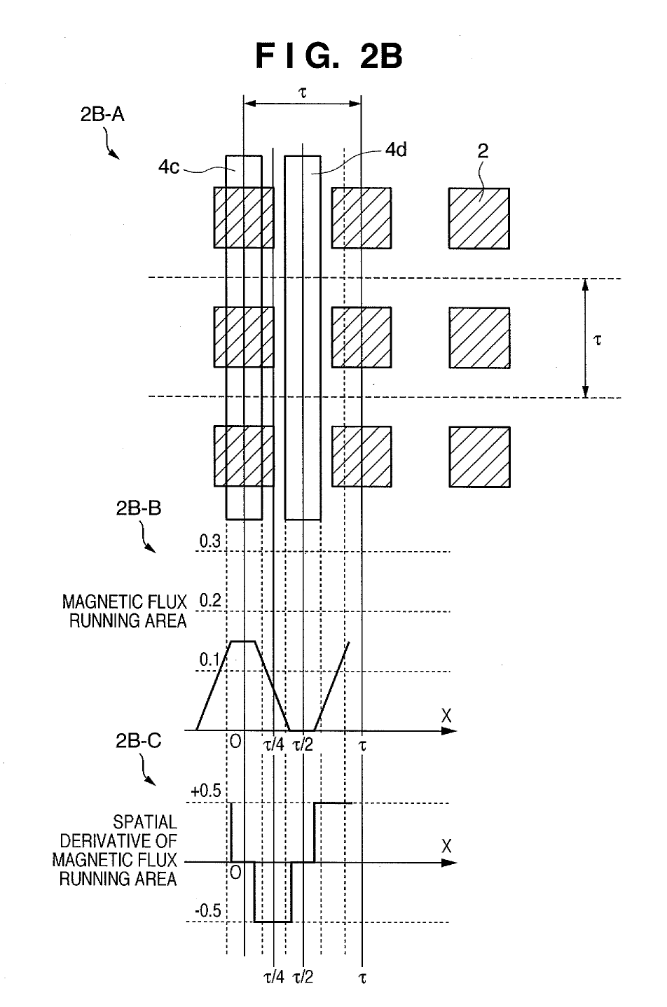

FIG. 2A is a view for explaining a magnetic flux which runs through the convex portions of the stator shown in FIG. 1A. FIG. 2B is a view for explaining a magnetic flux which runs through the convex portions of the stator shown in FIG. 1B. Referring to FIGS. 2A and 2B, τ is the arrangement pitch (one cycle of arrangement) of the convex portions, and a is the dimension of each tooth 4 of the movable element in its moving direction (the x direction in FIGS. 2A and 2B). Reference symbols 4a and 4c each indicate a tooth 4 at the origin, and reference symbols 4b and 4d each indicate a tooth 4 at the τ/2 position from the origin.

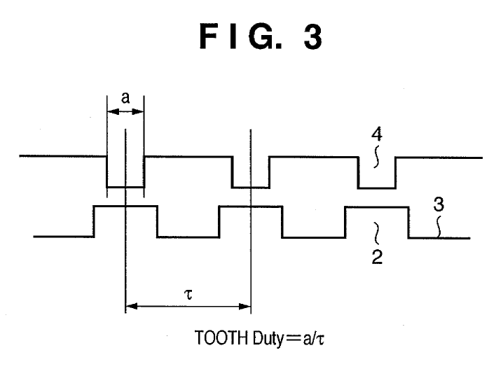

FIG. 3 is an explanatory view associated with tooth Duty. As described above, letting a be the dimension of each tooth 4 of the movable element in its moving direction, and τ be the arrangement pitch (one cycle of arrangement) of the convex portions of the stator in the moving direction of the movable element, the tooth Duty is defined by:

tooth Duty=a/τ

The tooth Duty can be set to, for example, about 0.3.

A thrust F of a planar motor is proportional to dφ/dx, which is the spatial derivative of a magnetic flux.

Of magnetic fluxes generated by electric currents flowing through the coils of the movable element, a magnetic flux which runs through the convex portions of the stator is proportional to the area (to be called the magnetic flux running area hereinafter) of a portion in which the cores overlap the teeth. 2A-B in FIG. 2A shows the magnetic flux running area in the stator shown in FIG. 1A. 2B-B in FIG. 2B shows the magnetic flux running area in the stator shown in FIG. 1B. 2A-C in FIG. 2A shows the spatial derivative of the magnetic flux running area shown in 2A-B of FIG. 2A. 2B-C in FIG. 2B shows the spatial derivative of the magnetic flux running area shown in 2B-B of FIG. 2B. In this case, the tooth Duty is 0.3.

The spatial derivative of the magnetic flux running area (proportional to dφ/dx) is proportional to the thrust F. The spatial derivative of the magnetic flux running area at the τ/4 position, at which a maximum thrust is produced, shown in 2A-C of FIG. 2A is 1.2 times that shown in 2B-C of FIG. 2B. That is, when the stator shown in FIG. 1A according to the preferred embodiment of the present invention is used, it is possible to obtain a thrust 1.2 times that when the stator shown in FIG. 1B according to the comparative example is used.

In one cycle length τ, the spatial derivative of the magnetic flux running area when the stator shown in FIG. 1A is used exhibits a higher continuity and a smoother change in thrust than those when the stator shown in FIG. 1B is used. Hence, the use of the stator shown in FIG. 1A according to the preferred embodiment of the present invention is more effective in suppressing vibrational movement such as cogging than the use of the stator shown in FIG. 1B according to the comparative example.

When the stator shown in FIG. 1A according to the preferred embodiment of the present invention is used, there is no interval in which the spatial derivative of the magnetic flux running area is zero, and therefore nonzero thrusts are ensured in all the regions. In contrast, when the stator shown in FIG. 1B according to the comparative example is used, there is an interval in which the spatial derivative of the magnetic flux running area is zero, that is, an interval in which a zero thrust is produced.

A change in magnetic flux running area in the stator shown in FIG. 1A is 1.4 times that in the stator shown in FIG. 1B. A change in magnetic flux running area is proportional to the average thrust in one cycle length τ. Accordingly, the average thrust when the stator shown in FIG. 1A according to the preferred embodiment of the present invention is used is 1.4 times that when the stator shown in FIG. 1B according to the comparative example is used.

As described above, the comparison using FIGS. 2A and 2B assumes tooth Duty=0.3. When tooth Duty=0.4, the average thrust when the stator shown in FIG. 1A according to the preferred embodiment of the present invention is used is 1.2 times that when the stator shown in FIG. 1B according to the comparative example is used.

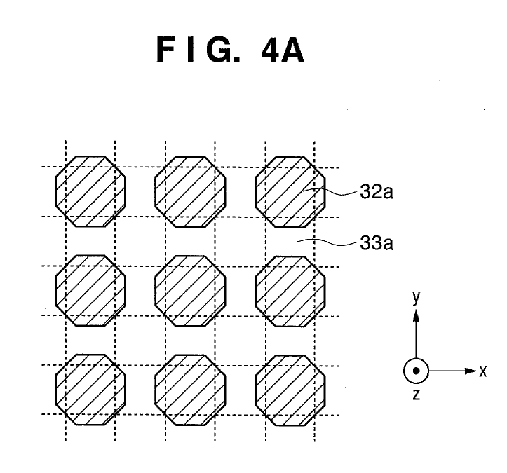

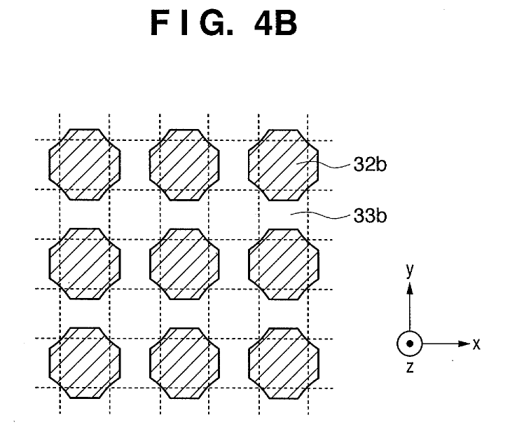

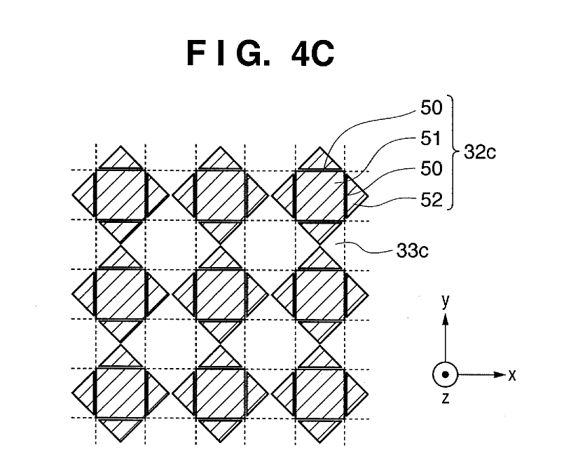

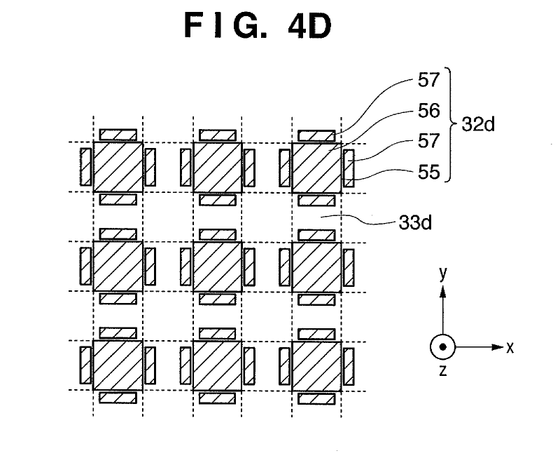

FIGS. 4A to 4D each show convex portions of a stator according to a modification. Although a movable element 300 is not illustrated in each of FIGS. 4A to 4D, it moves in the x direction and/or y direction.

In the modification shown in FIG. 4A, a stator is formed by arranging a plurality of convex portions 32a each containing a magnetic material. The portion between the convex portions of the stator is a recessed portion 33a. Each convex portion 32a is an octagon, that is, has a shape including eight corners. According to this modification, it is possible to minimize the magnetic flux running area at the τ/2 position. This reduces magnetic saturation.

In the modification shown in FIG. 4B, a stator is formed by arranging a plurality of convex portions 32b each containing a magnetic material. The portion between the convex portions 32b of the stator is a recessed portion 33b. Each core 32b has a shape in which each of the four corners of a quadrangle is cut in an arc and which includes eight corners. According to this modification, it is possible to minimize the magnetic flux running area at the τ/2 position. This reduces magnetic saturation. As will be described later, convex portions 32b each having such a shape facilitate the manufacture of a stator.

In the modification shown in FIG. 4C, a stator is formed by arranging a plurality of convex portions 32c each containing a magnetic material. The portion between the convex portions 32c of the stator is a recessed portion 33c. Slits 50 divide a convex portion 32c into one or a plurality of first portions 51 and one or a plurality of second portions 52. The slits 50 can be formed along the x direction (first direction) and/or y direction (second direction). It is also possible to apply such slits to the modifications shown in FIGS. 4A and 4B. The slits uniform a magnetic flux which runs out from the teeth of a movable unit and enters the convex portions of a stator. This reduces local magnetic saturation, thus improving the thrust of a planar motor.

In the modification shown in FIG. 4D, a stator is formed by arranging a plurality of convex portions 32d each containing a magnetic material. The portion between the convex portions 32d of the stator is a recessed portion 33d. Slits 55 divide a convex portion 32d into one or a plurality of first portions 56 and one or a plurality of second portions 57. As described above, such slits uniform a magnetic flux which runs out from the teeth of a movable unit and enters the convex portions of a stator. This reduces local magnetic saturation, thus improving the thrust of a planar motor.

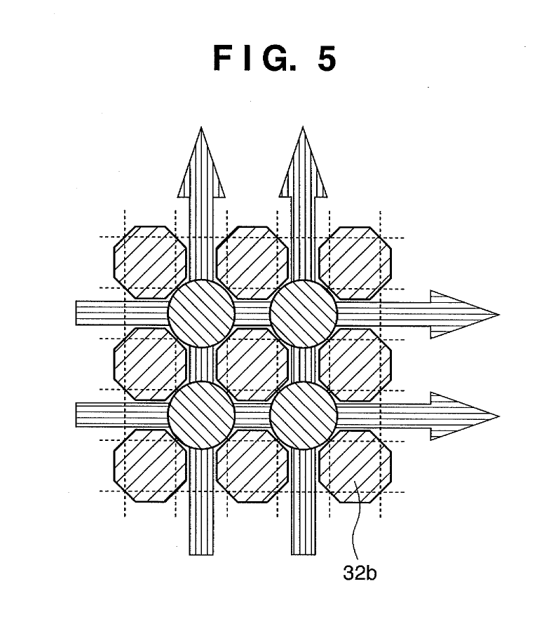

FIG. 5 is a view for explaining a method of forming the convex portions shown in FIG. 4B. As shown in FIG. 5, convex portions 32b are formed by cutting the surface of a silicon steel sheet to form recessed portions (grooves) which extend in the x and y directions, thereby forming periodical, square convex portions. Each intersection between the recessed portions (grooves) which extend in the x and y directions is then cut in an arc. Each intersection can be cut in an arc using a cutting tooth which rotates about the z-axis. This facilitates the manufacture of a stator as compared with a case in which the corners of a quadrangle are cut in a straight line as shown in FIG. 4A.

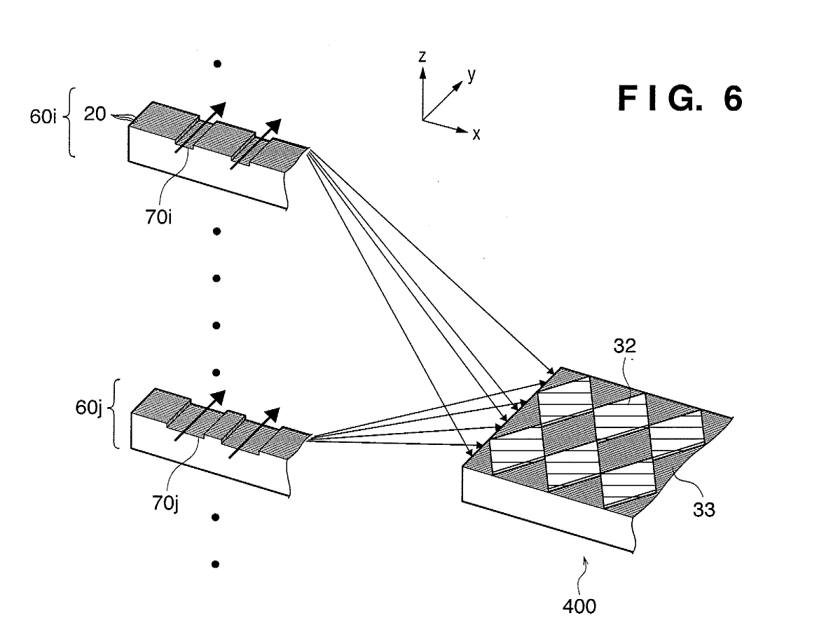

FIG. 6 is a view for explaining a method of forming the stator shown in FIG. 1A. First, silicon steel sheets 20 as magnetic materials are stacked in the y direction to form a plurality of rectangular parallelepiped blocks 60i and 60j. Grooves 70i and 70j having different widths are respectively formed in the plurality of blocks 60i and 60j. Then, the plurality of blocks 60i and 60j in which the grooves 70i and 70j are formed are brought into press contact with each other, thereby obtaining a stator 400. That is, the shape of each convex portion 32 is determined using the difference in width between the grooves 70i and 70j.

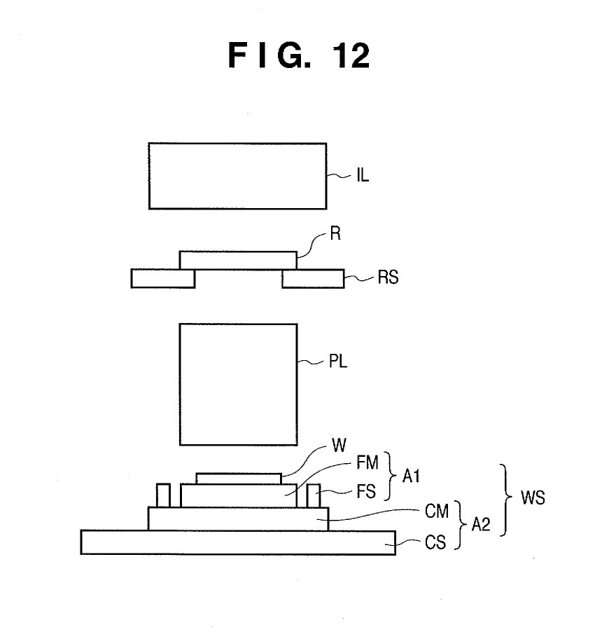

FIG. 12 is a view schematically showing the arrangements of a positioning apparatus and exposure apparatus according to the preferred embodiment of the present invention. The exposure apparatus can comprise an original stage unit RS for positioning an original (reticle) R, an illumination optical system IL for illuminating the original R, a positioning apparatus WS for positioning a substrate (wafer) W, and a projection optical system PL for projecting the pattern of the original R onto the substrate W. The exposure apparatus can be configured to project the pattern of the original R onto the substrate W to form a latent image pattern on a photosensitive agent applied on the substrate W.

The positioning apparatus WS can be called, for example, a substrate stage apparatus. The positioning apparatus WS can include the above-described planar motor as its driving unit. More specifically, the positioning apparatus WS can include a fine moving stage mechanism A1 for positioning the substrate W, and a coarse moving stage mechanism A2 for positioning the fine moving stage mechanism A1. The fine moving stage mechanism A1 can include a first stator FS and a first movable element FM including a substrate chuck for holding the substrate W. The coarse moving stage mechanism A2 can include a second stator CS and a second movable element CM for driving the first stator FS. The coarse moving stage mechanism A2 can include the above-described planar motor as its driving unit. That is, the second movable element CM of the coarse moving stage mechanism A2 can include the above-described movable element 300, while the second stator CS of the coarse moving stage mechanism A2 can include the above-described stator 400.

The above-described positioning apparatus WS is not particularly limited to a constituent component of an exposure apparatus, and can be adopted to position various kinds of objects. Note that the positioning apparatus herein can include a conveying apparatus which conveys an article.

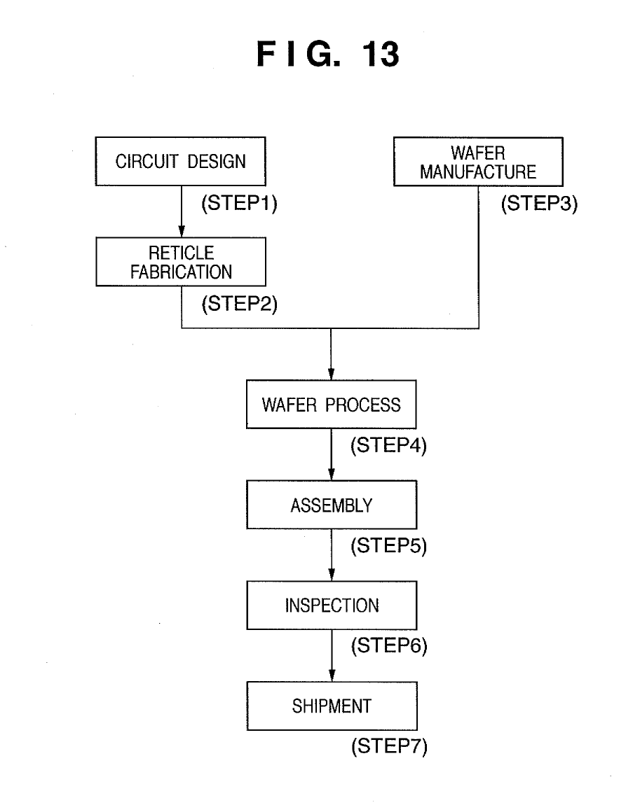

A device manufacturing method using the above-described exposure apparatus will be explained next. FIG. 13 is a flowchart illustrating the overall sequence of a process of manufacturing a semiconductor device. In step 1 (circuit design), the circuit of a semiconductor device is designed. In step 2 (reticle fabrication), a reticle (also called an original or mask) is fabricated based on the designed circuit pattern. In step 3 (wafer manufacture), a wafer (also called a substrate) is manufactured using a material such as silicon. In step 4 (wafer process) called a preprocess, an actual circuit is formed on the wafer by lithography using the reticle and wafer. In step 5 (assembly) called a post-process, a semiconductor chip is formed using the wafer manufactured in step 4. This step includes processes such as assembly (dicing and bonding) and packaging (chip encapsulation). In step 6 (inspection), inspections including operation check test and durability test of the semiconductor device manufactured in step 5 are performed. A semiconductor device is completed with these processes and shipped in step 7.

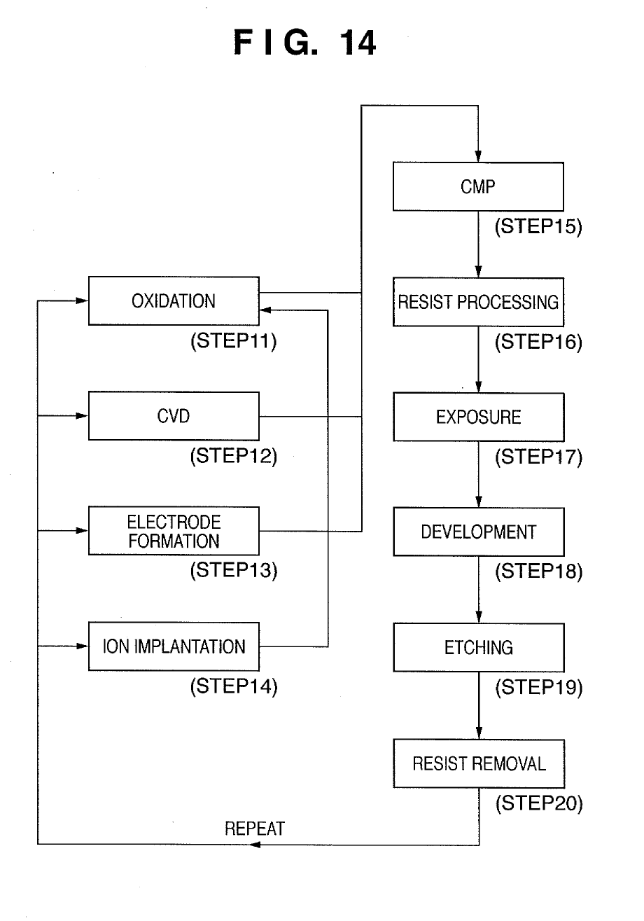

FIG. 14 is a flowchart illustrating the detailed sequence of the wafer process. In step 11 (oxidation), the wafer surface is oxidized. In step 12 (CVD), an insulating film is formed on the wafer surface. In step 13 (electrode formation), an electrode is formed on the wafer by vapor deposition. In step 14 (ion implantation), ions are implanted into the wafer. In step 15 (CMP), the insulating film is planarized by CMP. In step 16 (resist processing), a photosensitive agent is applied on the wafer. In step 17 (exposure), the above-described exposure apparatus is used to form a latent image pattern on the resist by exposing the wafer coated with the photosensitive agent to light via the mask on which the circuit pattern is formed. In step 18 (development), the latent image pattern formed on the resist on the wafer is developed to form a resist pattern. In step 19 (etching), the layer or substrate under the resist pattern is etched through an opening of the resist pattern. In step 20 (resist removal), any unnecessary resist remaining after etching is removed. By repeating these steps, a multilayered structure of circuit patterns is formed on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-060906, filed Mar. 9, 2007, which is hereby incorporated by reference herein in its entirety.

1. A planar motor comprising a stator in which a plurality of convex portions each containing a magnetic material are arranged, and a movable element which faces the stator, the movable element including a plurality of coils and moving in at least a first direction by controlling electric currents flowing through the plurality of coils,
wherein each convex portion has different dimensions in a second direction perpendicular to the first direction at least at two positions on a straight line along the first direction.

2. The motor according to claim 1, wherein the plurality of convex portions are arranged in a checkerboard pattern.

3. The motor according to claim 1, wherein each convex portion has a shape including eight corners.

4. The motor according to claim 1, wherein each convex portion is formed by a plurality of portions divided by a slit.

5. The motor according to claim 4, wherein the slit extends in one of the first direction and the second direction.

6. The motor according to claim 1, wherein each convex portion has a contour including a side parallel to neither the first direction nor the second direction.

7. The motor according to claim 1, wherein letting τ be an arrangement pitch of the plurality of convex portions in the first direction, and D be a maximum dimension of each convex portion in the first direction, D/τ>0.5.

8. A positioning apparatus which positions an object, comprising
a planar motor defined in claim 1 as a driving unit of the positioning apparatus.

9. An exposure apparatus which transfers a pattern of an original onto a substrate, comprising:
a positioning apparatus configured to position the substrate;
a projection optical system configured to project the pattern of the original onto the substrate; and
a planar motor defined in claim 1 as a driving unit of the positioning apparatus.

10. A device manufacturing method comprising the steps of:
exposing a substrate to light using an exposure apparatus defined in claim 9; and
developing the substrate.

11. A planar motor comprising:
a stator in which a plurality of convex portions each containing a magnetic material are arranged; and
a movable element which faces the stator,
the movable element including a plurality of coils and a plurality of teeth,
wherein the movable element moves in at least a first direction using a magnetic flux generated by controlling electric currents flowing through the plurality of coils, and
as the teeth and the convex portions move relative to each other upon the movement of the movable element in the first direction, a spatial derivative of a magnetic flux running area, as an area of a region in which the magnetic flux runs through a portion in which the plurality of convex portions overlap the teeth, gradually increases and decreases.

12. A planar motor comprising:
a stator including a recessed portion and a plurality of convex portions each containing a magnetic material; and
a movable element which faces the stator,
the movable element including a plurality of coils,
wherein the movable element moves by controlling electric currents flowing through the plurality of coils,
each of the convex portions is a quadrangle in which four corners are adjacent to each other and four sides are adjacent to the recessed portion, and
the movable element moves in a direction along at least one of axes running on diagonals of each of the convex portions.

13. A planar motor comprising:
a stator in which a plurality of convex portions each containing a magnetic material are arranged; and
a movable element which faces the stator,
the movable element including a plurality of coils,
wherein the movable element moves by controlling electric currents flowing through the plurality of coils, and
each of the convex portions has a shape including four corners, and the convex portions are arranged such that an interval between an edge of a given convex portion and an edge of a convex portion closest to the given convex portion becomes less than half an interval between the center of the given convex portion and the center of the convex portion closest to the given convex portion.

14. A planar motor comprising:
a stator in which a plurality of convex portions each containing a magnetic material are arranged; and
a movable element which faces the stator,
the movable element including a plurality of coils,
wherein the movable element moves in at least a first direction by controlling electric currents flowing through the plurality of coils, and
each of the convex portions has a shape including eight corners, and the convex portions are arranged such that an interval between an edge of a given convex portion and an edge of a convex portion closest to the given convex portion becomes less than half an interval between the center of the given convex portion and the center of the convex portion closest to the given convex portion.
